(19) United States
(12) Patent Application Publication
(10) Pub. No.: US 2006/0063667 A1
(43) Pub. Date: Mar. 23, 2006

(54) Photo-catalyst physical water molecule for medical purposes

(76) Inventor: Tsai-Chuan Lu, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/943,889

(22) Filed: Sep. 20, 2004

(51) Int. Cl. B01J 23/00

(52) U.S. Cl. 502/349

(57) ABSTRACT

Photo-catalyst physical water molecule for medical purposes comprised of mixture of aqua pura and TiO2 at the ratio of 1:1 at a temperature range of 50˜60° C. to be ground and refrigerated in flasks of a first semi-product, to be added with aqua pura at the ratio of 1:1 and well mixed to become a second semi-product, then diluted with aqua pura and mixed well to indicate a viscosity of 800˜10000 centipoises; stored and sealed in a transparent container to undergo photosynthesis for 24 hours at a temperature range of 40˜50° C.; impurities settled and rid off together with 1% suspension to avail solution of 20% solid containment, finally diluted with approximately 100% aqua pura to 0.3˜0.8% and viscosity of 800˜10000 centipoises.

### BACKGROUND OF THE INVENTION

(a) Field of the Invention

The present invention relates to photo-catalyst physical water molecule for medical purposes, and more particularly, to a nanometer water molecule catalyst that has repeatedly grind aqua pura and TiO₂ into fine grains and well mixed, then stored with photosynthesis, condensed, filtered, and diluted with approximately 100% aqua pura into 0.3%˜0.8% solution with a viscosity of 800˜10000 centipoises for human body purification and clean environment including medical, environmental protection, sterilization, and anti-fungus purposes.

(b) Description of the Prior Art

Conventional photo-catalyst is usually prepared by TiO₂ in nanometer size and chemical adhesive. However, when organic epoxy adhesive is added, insufficient amount of the additive will burst the powder, and excessive amount of additive fails the results expected since toxic gas is prevented from conversion. When inorganic epoxy adhesive is added, insufficient amount of the additive fails adhesion, and excessive amount of the additive results in excessive burst metal powder.

The photo-catalyst added with chemical adhesion of the prior art is successful in air cleaning, sterilization and deodorizing applications at a place of ambient temperature ranging 35˜40° C.; however, when the temperature of the photo-catalyst rises to 70° C. or higher, it gets more active to degrade the chemical adhesion. Consequently, the nanometer grains burst and the adhesion becomes brittle to cause serious contamination. Since they are so too small to be discharged by digestion duct, these burst grains when inhaled by human body will settled down in the lungs and cause permanent damage. Things could get worse if the additive relates to alcohol or chemical agent.

### SUMMARY OF THE INVENTION

The primary purpose of the present invention is to provide photo-catalyst physical water molecule for human body purification and clean environment purposes including various medical, environmental, sterilization, and anti-fungus application. To achieve the purpose, aqua pura and TiO₂ are mixed at a ratio of 1:1, ground, refrigerated, and processed into flakes of a first semi-product; the first semi-product is then mixed well with aqua pura also at the ratio of 1:1 and ground into a second semi-product; and the second semi-product is further diluted with aqua pura at the ratio of 1:1 and mixed well to indicate a viscosity of 800˜10000 centipoises then sealed and stored to undergo photosynthesis for 24 hours at a temperature range of 40˜50° C. to be exposed to radiation for the impurities to settle down and filtered into a solution with 20% solid containment. Finally, 1% suspension, and foreign matters and impurities of the sediments are removed before being diluted with approximately 100% aqua pura into 0.3%˜0.8% concentration at a viscosity of 800˜10000 centipoises, and well mixed to become the nanometer water molecule photo-catalyst. The present invention for not adding into any organic or inorganic adhesion eliminates the defective of burst grains due to the improper amount of added adhesion as found with the prior art.

### DETAILED DESCRIPTION OF THE PREFERRED EMBODIMENTS

The photo-catalyst physical water molecule for medical purposes of the present invention is prepared by having mixed aqua pura and TiO₂ at the ratio of 1:1 at a temperature range of 50˜60° C., fine ground, refrigerated and processed into flakes of a first semi-product. The first semi-product is added with aqua pura at the ratio of 1:1 and well mixed, ground into a second semi-product. The second semi-product is diluted with aqua pura at the ratio of 1:1 to indicate a viscosity of 800˜10000 centipoises and well mixed, sealed in a transparent bucket and stored to undergo photosynthesis for 24 hours at a temperature range of 40˜50° C. and exposed to radiation to settle down impurities, then filtered to become a solution with 20% solid containment. 1% suspension and the impurities and foreign matters in the sediments are removed before adding approximately 100% aqua pura to be diluted to a concentration of 0.3˜0.8% and a viscosity of 800˜10000 centipoises. The solution is finally well mixed to become photo-catalyst physical water molecule for medical purposes.

In the production of the present invention, the following materials and equipment are required:

1. TiO₂: must be pure, crystal like, strict white without contamination, free of foreign materials, free of chemical compounds, excellent process quality for fine grinding, electricity bearing, with a grain size averaged below 3000 nanometers.

2. Aqua pura: must be pure, free of other minerals, free of organics, free of additives, free of ferrous substance.

3. Container for process: must be fine and smooth, sealed with a lid, dual-layer of cooling and heating.

4. Production site: air conditioned, clean, equipped with temperature controlled room, light controlled room, kept at a constant ambient temperature of 20° C.

5. Mechanical equipment: must be clean, rinsed before production to make sure of keeping clean, free of foreign matters; rinsed again after production without leaving any residuals.

6. Test and inspection instruments: must be kept clean, rinsed to clean immediately after use, no foreign matter is allowed near the instrument.

7. Operators: only those who known for keeping good personal sanitary habit shall be assigned to the process.

The detailed process is described as follows:

1. Aqua pura and TiO2 at the ratio of 1:1 are mixed and ground for 48 hours at a temperature range of 50˜60° C. given with a test once each at the 24^{th} and the 48^{th} hours to such extent that the grain size profile shall be of 100˜1000 nanometers and at a viscosity of 30000 centipoises.

2. Lower the temperature of the solution down to 0˜20° C. in paste and freeze for 24 hours, and process the iced paste into flakes of a first semi-product.

3. Add aqua pura at the ratio of 1:1 into the first semi-product and mix well the solution and grind the mixture for 72 hours with a test run each at the 24^{th}, the 48^{th}, and the 72^{nd} hours to such extent with the grain size profile under 100 nanometers into paste status of a second semi-product at the viscosity of 1500 centipoises.

4. Dilute the second semi-product with aqua pura at the ratio of 1:1 for the solution to indicate a viscosity of 800˜10000 centipoises, then mix well the solution to be ground into flattened grains in a size under 30 nanometers for 24 hours with a test run every 8 hours until the fineness, shape, electromagnet, settlement, viscosity, and crystal brightness meeting the consistence standard in three tests.

5. The solution is then stored in the sealed, transparent bucket to undergo photosynthesis for 24 hours at a temperature range of 40˜50° C., and exposed to radiation to settle down impurities.

6. Filter the finished product of the TiO2-water photo-catalyst high concentration solution with 20% of solid containment and refined reactants cleaned and purified; 1% suspension and foreign matters and impurities of the sediments are rid off.

7. Add approximate 100% aqua pura to dilute the finish product into a concentration of 0.3˜0.8% (e.g., 0.3%, 0.5%, 0.8%) to indicate a viscosity of 800˜10000 centipoises and well mixed.

As mentioned aforesaid, the photo-catalyst physical water molecule of the present invention can be applied in human body purification and environment purification including medical, environmental protection, sterilization, and anti-fungus purposes.

1. Powdered Chinese cypress, Chinese herbal, and vanilla are added into the present invention to be dehydrated and well mixed in a pressurized vacuum vessel to force photo-catalyst physical water molecule into capillary fiber of the powder before packed into an air permeable fabric sachet.

2. The fabric sachet may be in a form of hanging bag, pillow, jacket pocket, thin sheet (to be adhered to a chair or on a bed), and placed in the car, at home or in the office to deodorize, sterilize, dehumidify, clean the air, and emit fragrance for curing and refreshing purposes when exposed to light or sunshine. Furthermore, when the sachet is applied in a pillow or sheet to contact the human skin for fending off fungus, help cure skin diseases; or when the sachet is dipped in water, it help purify water quality, skin care, and cure skin diseases.

I claim:

1. Photo-catalyst physical water molecule for medical purposes being prepared by grinding mixture of Aqua pura and TiO2 by the following process:
a. aqua pura and TiO2 at the ratio of 1:1 are mixed and ground for 48 hours at a temperature range of 50˜60° C. given with a test once each at the 24^{th} and the 48^{th} hours to such extent that the grain size profile shall be of 100˜1000 nanometers and a viscosity of 30000 centipoises;
b. Lower the temperature of the solution down to 0˜20° C. in paste and freeze for 24 hours, and process the iced paste into flakes of a first semi-product;
c. Add aqua pura at the ratio of 1:1 into the first semi-product and mix well the solution and grind the mixture for 72 hours with a test run each at the 24^{th}, the 48^{th}, and the 72^{nd} hours to such extent with the grain size profile under 100 nanometers into paste status of a second semi-product at a viscosity of 1500 centipoises;
d. Dilute the second semi-product with aqua pura at the ratio of 1:1 for the solution to indicate a viscosity of 800˜10000 centipoises, then mix well the solution to be ground into flattened grains in a size under 30 nanometers for 24 hours with a test run every 8 hours until the fineness, shape, electromagnet, settlement, viscosity, and crystal brightness meeting the consistence standard in three tests;
e. The solution is then stored in a sealed, transparent bucket to undergo photosynthesis for 24 hours at a temperature range of 40˜50° C. , and exposed to radiation to settle down impurities;
f. Filter the finished product of the TiO2—water photo-catalyst high concentration solution with 20% of solid containment and refined reactants cleaned and purified; 1% suspension and foreign matters and impurities of the sediments are rid off; and
g. Add approximate 100% aqua pura to dilute the finish product into a concentration of 0.3˜0.8% to indicate a viscosity of 800˜10000 centipoises and well mixed.

2. The photo-catalyst physical water molecule for medical purposes of claim 1, wherein TiO₂ used must be pure, crystal like, strict white without contamination, free of foreign materials, free of chemical compounds, excellent process quality for fine grinding, electricity bearing, with a grain size averaged below 3000 nanometers.
